(19) United States
(12) Patent Application Publication
(10) Pub. No.: US 2016/0147963 A1
(43) Pub. Date: May 26, 2016

(54) SYSTEM AND PROCESS FOR PATIENT DETECTION, REGISTRATION, FOLLOW-UP AND MANAGEMENT OF RELATED DOCUMENTS DURING CLINICAL TRIALS

(71) Applicant: Yoram BOUHNIK, Paris (FR)

(72) Inventor: Yoram BOUHNIK, Paris (FR)

(21) Appl. No.: 14/765,383

(22) PCT Filed: Aug. 8, 2014
(86) PCT No.: PCT/EP2014/067073

§ 371 Date: Aug. 3, 2015

(30) Foreign Application Priority Data
Aug. 8, 2013 (FR) 1357905

(51) Int. Cl. G06F 19/00

(52) U.S. Cl. CPC G06F 19/3406; G06F 19/322; G06F 19/363

(57) ABSTRACT

A computer system for patient detection, registration, follow-up and management of related documents during at least one clinical trial, includes at least one server having at least one clinical trials database that has at least eligibility criteria for the or each clinical trial, and an interactive interface displaying questions relating to eligibility criteria, allowing entering answers to said questions, communicating, through a communication network with the server and the clinical trials database, and displaying eligibility information. The server is programmed to determine whether a patient is eligible for a clinical trial, to generate a unique encoded identifier for each eligible patient participating in a clinical trial, to generate documents including the unique encoded identifier and data related to the clinical trial to ensure patient anonymity. One or more databases including eligible patient data related to patients who agree to participate in a clinical trial and responsible staff data are provided.

The invention relates to a system and a process for patient detection, registration and management of eligible patients during clinical trials. The invention also proposes a solution for the management of related documents during the clinical trials. For the purpose of this Application, clinical trial means “scientific studies in human or animal medical therapy to evaluate the efficiency and safety of a diagnostic method or treatment” or “any research project that prospectively assigns human or animal subjects to intervention and comparison groups to study the cause and effect relationship between a medical intervention and the evolution of a state of health.”

These trials correspond to scientific, prospective studies, randomized controlled blind or unblinded, single or multicenters, and they must have been approved by Ethics Committee as well as Regulatory Authorities.

Clinical trials are a prerequisite for validating the efficiency and safety of a new drug. To do this, pharmaceutical companies (or Sponsors) rely on investigators who are health professionals and are responsible for a research centre. These trials must follow very strict legal frameworks, with a number of constraints, both technical and ethical.

These requirements can incur a very high cost of management, and pose financial risks for pharmaceutical companies.

Thus, a clinical trial in stage II costs on average $200 million. This takes into account the costs of clinical trials that could not be brought to completion due to technical constraints (e.g. cancellation of the study due to an insufficient number of patients, loss of mandatory documents . . . ) or ethical constraints.

The general challenges for any investigator involved in clinical research in humans are:
a) Difficulty in memorizing all criteria for inclusion and non-inclusion of each study, especially as the number of concurrent studies in which investigators are involved is constantly increasing;
b) The need to inform and educate his staff so that all potentially eligible patients are identified;
c) Allocate the availability of a team member for the selection, inclusion and follow up of patients, due to substantial administrative constraints that are necessary to ensure that the clinical trial is maintained in a current and active state.

In addition, major financial investments by the sponsors to sustain the clinical trial can cause significant psychological pressure and stiff competition between the centers (as they attempt to recruit the same target population, in a limited timeframe, necessary to evaluate the product), both on an scientific and medical point of view, but also a competition between different products, each hoping to be the best option for a specific patient population.

In a given field, the number clinical trials may be increasing and often differ only in details for which it is not obvious to an investigator involved in various clinical trials. Each clinical trial is preceded by the investigators meetings or an initiation visit at the center. This requires the availability of many people to review the eligibility criteria, as well as outlines of the study and management of side effects, the most crucial element being a legal obligation to report them in a very short timeframe. These meetings are time-consuming and difficult to implement, multiple and not very effective as it is difficult to memorize all the information discussed during the meeting.

Full details of the study are available in a study site file, but these are usually large binders that are not easily accessible, and are available only to research staff!

Pocket books or pamphlets have been popular at times. However, their accumulation in one's pocket and the need for amendments makes them quickly obsolete. In addition, these printed materials provide only limited information while the burdens of increasing bureaucracy create the need to have at one owns' disposal crucial elements that only modern storage techniques can offer.

An object of the invention is to provide a computer system and a process helping detection and registration of patient eligible to participate in clinical trial.

Another object of the invention is to provide a computer system and a process able to follow up and to manage documents related to patients participating in a clinical trial, while ensuring the anonymity of patients.

Another object of the invention is to provide a computer system and a process able to follow up and to manage incident/accident out of the clinical trial of a patient participating to said clinical trial, in order to prevent any cause of cancellation of the clinical trial.

To this end, the invention relates to a computer system for patient detection, registration, follow-up and management of related documents is during at least one clinical trial, the system comprising:
At least one server linked to a communication network, said server comprising at least one clinical trials database comprising at least eligibility criteria for the or each clinical trial;
An interactive interface adapted:
   to display questions relating to eligibility criteria,
   to allow entering answers to said questions;
   to communicate, through a communication network, with said server and said clinical trials database,
   to display an eligibility information,
the server being programmed:
   to compare the answers to the eligibility criteria,
   to generate said eligibility information as a result of the comparison,
   to communicate said eligibility information to the interactive interface,
   to generate a unique encoded identifier for each eligible patient participating in a clinical trial
   to generate documents comprising said unique encoded identifier and data related to the clinical trial;
A database comprising eligible patient data related to patients who accept to participate in a clinical trial, the data comprising:
   personal contact information
   numerical copies of documents signed by the patient
A database comprising responsible staff data, the data comprising staff members contact information.

According to other embodiments:
the computer system may further comprise a capture device adapted to capture numerical images of documents signed by a patient agreeing to participate in a clinical trial and to send the numerical images to the server through the communication network;
the computer system may further comprise a printer linked to the server through the communication network, the printer being able to print documents comprising a unique encoded identifier generated by the server and data related to the clinical trial;
the database comprising eligible patient data may further comprise a schedule of programmed medical visits in relation with the clinical trial, the computer system further comprising a reminder message sender device programmed to send reminder message to each elected patient;
the server may also be programmed:
   to receive the unique encoded identifier together with a phone number
   to generate a serious adverse event information in response to the reception of the unique code identifier scan and the phone number
   to send said serious adverse event information to the responsible staff via the communication network
   to transmit Clinical Trial related information to the phone number;
the server may also be programmed to send a message comprising the received phone number to the responsible staff to call this phone number.

The invention also relates to a process for patient detection, registration follow-up and management of related documents during at least one clinical trial, the process comprising the following steps of:
(a) providing a computer system according to anyone of claims 1 to 6
(b) answering questions relating to eligibility criteria displayed on an interactive interface;
c) comparing the answers to the eligibility criteria,
d) generating eligibility information as a result of the comparison,
e) communicating said eligibility information to the interactive interface of the provided system,
f) generating a unique encoded identifier for each eligible patient participating in a clinical trial
g) generating documents comprising said unique encoded identifier and data related to the clinical trial.

According to other embodiments:
the process may further comprise a step h) of manufacturing an object wearable by a patient and comprising on a visible surface a unique encoded identifier corresponding to said patient;
in order to notify a serious adverse event concerning a given patient, the process may further comprise the steps of:
   i) by a person different from the responsible staff, sending to the server via the communication network the unique encoded identifier located on the object worn by the given patient and a phone number where the person may be contacted
   j) generating a serious adverse event information in response to the reception of the unique code identifier scan and the phone number
   k) sending said serious adverse event information to the responsible staff via the communication network
   l) transmitting Clinical Trial related information that can warn the person having sent her phone number in order to avoid treatment and/or drugs incompatible with the clinical trial;
the process may further comprise the step m) of sending a message comprising the phone number of the person to the responsible staff to get in contact with the person and help her;
the process may further comprise the step n) of sending reminder to the responsible staff to report the incident within a determined deadline.

The accompanying drawings, which are included to provide a further understanding of the invention and to illustrate embodiments of the invention together with the description, serve to explain the principle of the invention. In the drawings:

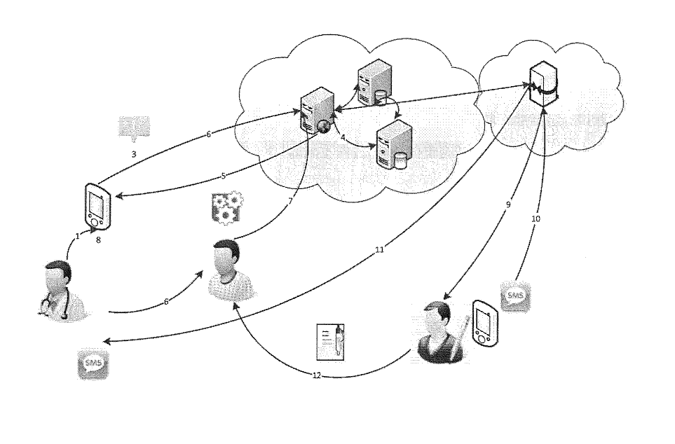

FIG. 1 is a schematic diagram of an embodiment of the method according to the invention to detect and to register patients;

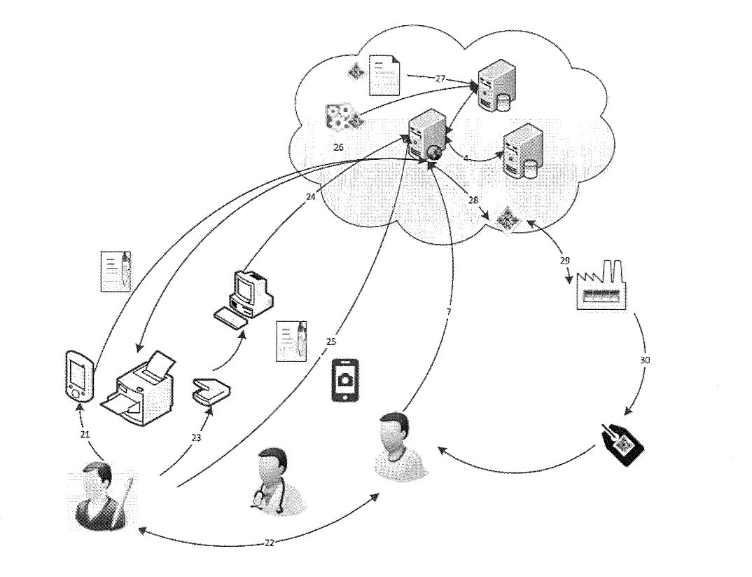

FIG. 2 is a schematic diagram of an embodiment of the method according to the invention to register the signed consent of patients, and to anonymise patient data;

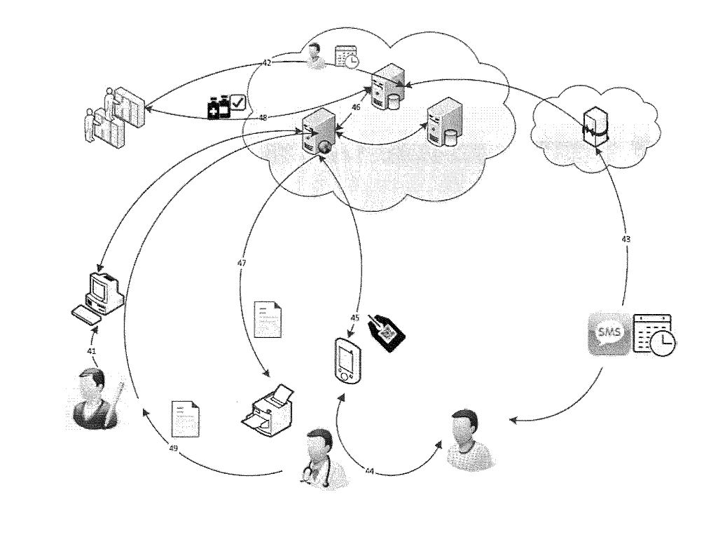

FIG. 3 is a schematic diagram of an embodiment of the method according to the invention to automatically follow up and manage related documents during clinical trials;

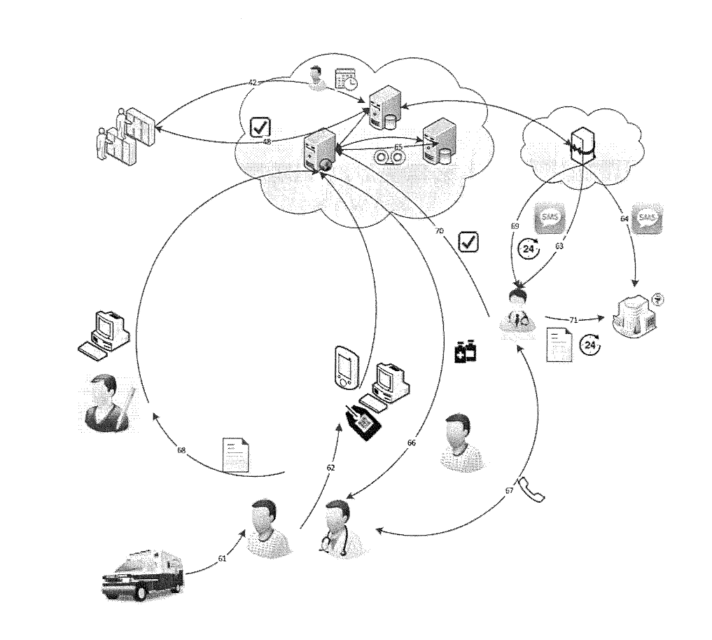

FIG. 4 is a schematic diagram of an embodiment of the method according to the invention to follow up and manage incident/accident of a patient included in a clinical trial.

The present invention relates to a detection system, registration and management of eligible patients in clinical trials.

The invention consist of a mobile application (on smartphones, tablets or laptops) and linked to an IT service, allowing a physician to rapidly detect a potentially eligible patient by answering a few questions, the study(ies) for which the patient is eligible for and initiate the alert to the research team to take over the screening activities. This is available for all types of clinical studies, and helps to solve the issue of patient pre-screening.

The features of this invention will therefore provide a fast, simple, effective and comprehensive tool to confirm the eligibility of a potential patient in a study, and submit this information in real time through a coded language (QS CNIL) to the Study Coordinator or Investigator in charge of the study; as well as providing the sponsor a possibility to monitor screening and recruitment efforts at research sites.

Study documents, such as synopsis . . . will also be available immediately. If necessary, it is also possible for the sponsor to inform the Investigators in real time about changes in the study, reminders, Safety alerts, Suspension of recruitment and so on.

The most specific problem solved by the invention is that from a single application, the coded search engine uses some major keywords to locate trials at a specific centre, as well as which study the patient would be eligible for and prioritize based on the protocol requirements. The process results in a few studies that the investigator can discuss and choose the one that is most suited to the patient. This could be further deepened by complexity of a trial, difficulty finding eligible patients with specific criteria, or the requirement to meet target enrolment. This will offer a better choice to the physician to discuss with and ultimately make the best decision for his patient.

Subject to strict security codes, access to the application will be given to interns and other physicians at the hospital, those seeing patients at the front line, i.e. in ER or walk in clinics, but who are not aware of current protocols or about their eligibility criteria.

A two-step process is setup; first to identify potentially eligible patient then a direct contact with a member of the research team for obtaining consent and initiating screening activities.

Prioritization of these studies is achieved by using an algorithm containing the keywords for each study initially classified on aggregate data and secondarily on specific data. More specifically, the application is to ask scripted questions to establish the eligibility of the patient for a clinical trial, and guide the investigator when participating in several trials either academic or industrial.

It is therefore a mobile application for smartphones, tablets, laptop or any other communicating device by a user, encrypted and secured to facilitate and optimize the recognition and monitoring of eligible patients in academic or industry sponsored clinical trials. The application is paired with modern techniques for secure transmission of data (anonymized barcodes, scanners, intangible storage and secured servers)

The novelty is the generation of a secure identifier coded specifically for a given patient (ID or a bar/QR code that can be scanned, alternatively, this could be an alphanumeric code that can be entered manually on a computer if needed), this bar/QR code will allow transmission of anonymized data that can be linked back to a patient at a site, as the barcode will be kept in the patient medical file for confirmation. It is similar to the usual patient ID number but will prevent inadvertent confusion due to similar initials or errors in the ways the numbering is recorded. The site staff will only be required to scan the patient barcode or QR and the test bar code prior to each specific study activity to confirm that it is done, allowing easy follow up for the sites, the CRA and the sponsor, and helping the site comply with the study procedures, as a reminder system will be built in for each study. All study documents can then be edited using the system according to the invention, so that no patient information is present on these documents except for the coded ID. This ensures complete anonymity for data transfer.

One of the most important features of the system is the ability to confirm that the ICF was signed prior to any study related activity, as the timestamp of each task would be tracked and reports will be provided to the sponsor.

Details: Once a patient has been identified and after review from a member of the research team, and confirmed his desire to participate in a trial, it will be possible to either order through a linked printer the documents required for the screening process as the Informed Consent Form (hereafter ICF) and screening forms, or for the research team to obtain further information on the procedures necessary for the screening process and make appropriate scheduling. The ICF may already contain the bar code for this patient as the system will automatically issue it and link it to the appropriate ICF. Nevertheless, it is preferred that the bar code (or any other unique code) is generated after the signature of the ICF.

When an Informed Consent is signed, it can be scanned in real time (existing application) and transmitted to ad hoc staff.

The second important point is to ensure compliance with

Serious Adverse Events reporting.

In addition to the above, the process according to the invention provides each patient included in the study with his (her) personal identifier on a wearable object. This object, which can be for example a bracelet, a necklace, a pendant, a card, a temporary tattoo or sticker, is designed to be worn continuously by the patient, or easily accessible. Preferably, the identifier is a scanned code such as a barcode or QR code (flash code). Alternatively, the identifier is an alphanumeric code that can be entered manually on a conventional computer keyboard.

In case of an emergency or an accident, any EMT or physician treating the patient can scan the coded identifier (barcode, QR code, etc . . . ) with their own smartphone, or enter the ID if it is alphanumeric, on a dedicated server, which will be specified with the code bar.

The system then transmits a message that can be one and\or other of the following:
Medical information transmitted on the Smartphone which was used to scan or enter the identifier that can warn the EMT or treating physician of a drug incompatibilities related to the clinical trial and/or emergency procedures for this patient;
Information sent to the investigative site of the occurrence of an accident\incident asking the investigator or a designated physician to get in contact with the physician treating the patient.

The system will store the date and time of the message with the scan or the identifier provided.

At no time, does the system transmit information about the trial itself to a physician who is not part of the research team.

Last but not least, the system will help site compliance with study procedures by sending reminders for specifically important procedures for study endpoints. The Investigator or his staff will scan the code bar at the beginning of the visits and the system will flash out what must be done at this visit. It can also be set to send an alert to the site if a specific procedure requires scheduling before a visit due to hospital capacities, or to send the patients a reminder about the visit or to bring their diaries, biological samples or return a used drug to the visit, etc . . . The possibilities are endless

This part can be linked through an interface to the sponsor\CRO portal, allowing tracking and ensuring compliance without violating patient privacy as the secured server will act as a buffer between the site and the sponsor\CRO.

Additionally, when a physician wants to prescribe a specific treatment, the invention will utilize the link (interface) to the CRO portal in order to avoid incompatibilities with the molecule that is being tested as part of the clinical trial. A specific interface will be provided to the physician in order to describe the treatment to be administered. This feature will diminish the risk of a Serious Adverse Event by limiting the chance of a drug reaction with the treatment administered as part of the clinical study.

In summary:

The CTMA system helps increase patient identification for clinical trials, improves the chances that a study is carried to term, thus reducing clinical trials costs, and hopefully the cost of drugs.

The system may also allow promising molecules to not be permanently discontinued due to lack of resources, insufficient patients, missing data or error during the study.

In addition, CTMA system will help prevent accidental treatment for a patient participating in a clinical trial (contraindicated drug as per protocol given by another physician unknowingly).

Specifically, the system includes:
A database of clinical trials and eligibility criteria for each trial listed;
An interactive interface to communicate with the trials database, display inclusion criteria, allow to enter answers to the questions; the system will compare the answers to the inclusion criteria;
A secured database of patients who consented to participate in a clinical trial, this includes copies of documents signed by the patient and information regarding patient contact for the reminders etc . . .
A system generating unique encoded identifiers and individually assigned to each patient participating in a study;
A database of responsible research staff for each centre and their contact information, as well as person who are identified as user for a specific study at a centre
Optional, a database of caregivers authorized to scan the unique encoded identifiers.

### FIG. 1 Illustrates the Detection Phase.

After logging in, the user will see any pending notices on the main page.
1. User launches application on the mobile device.
2. User's ID is authenticated on the Application Server on Cloud.
3. An optional notification is displayed in order to advise user of any relevant updates/changes.
4. Server retrieves studies relevant to users (therapeutic areas or center).
5. Server generates the appropriate questionnaire.
6. User interviews patient by asking him the relevant questions as presented on the screen of the mobile device. Alternatively, the user is able to answer the questions based on the medical data comprised in the patient medical file. This allows the application to determine.
7. Based on the answers given in step 6, the application determines whether the patient is eligible to a clinical trial or not, and the studies for which the patient is eligible.
8. The Primary Care Physician (hereafter “PCP”) further answers exclusion and inclusion criteria as presented on the mobile device.
9. The Application server sends a notification to the study personnel who are authorized to follow-up with the patient enrollment.
10. Enrollment personnel sends an SMS/Email to a Gateway Server acknowledging his acceptance to enroll the candidate patient
11. A message (e.g. SMS and/or Email and/or facsimile) is sent to Primary Care Physician to notify him of the Study personnel's acknowledgement to follow up with the Patient enrollment.
12. Study Personnel proceeds with manual process to obtain Informed Consent Form to be signed by a patient who agrees to participate.

### FIG. 1—Technical Contribution of the Invention

i. The invention will advise all the application users of any change to the protocol of an ongoing clinical trial as soon as such change is advertised by the Sponsor and updated on the system by the Study coordinator. It acts as an instant message which clearly identifies the specific change in a clinical trial.
ii. The expert knowledge of the Principal investigator and other medical specialists is encapsulated within a limited number of questions which the user can complete in a very short period of time (approximately one minute).
iii. The invention implements an algorithm to match the responses of the user to pre-defined criteria so that a list of studies is created for which the patient may be eligible to participate in.
iv. The application increases the inclusion rate of eligible patients by eliminating the need for the primary care physician to acquire an expert level of knowledge that would generally be required to establish a patient's eligibility.

### FIG. 2 Illustrates the Enrollment Phase.

After a patient was detected to be eligible, the Study personnel must obtain his signed consent.
21. Study personnel can use the application to retrieve the consent from a predefined networked printer if he does not already available to him.
22. After a discussion with the study personnel, the patient agrees to participate in a Clinical Trial and signs the consent form.
23. The consent form is scanned on a regular scanner. As an alternative, the form can be scanned by the smartphone application and sent directly to the application server. More generally, a numerical copy of the signed consent form is done by a scanner or a numerical camera.
24. The study personnel uses a PC based application to transmit the signed consent form to the application server.
25. As an alternative, the form can be scanned by the smartphone application and sent directly to the application server.
26. The server generates a unique encoded identifiers for each eligible patient participating to a clinical trial. For example, the server associates the application-generated patient number to an encrypted key and generates a new patient number (enrolled patient number).
27. The encrypted document is stored on the Document server. It will be accessible by authorized personnel only (based on the enrolled patient number).
28. A unique encoded identifiers (such as a bar code, a QR Code, or a specific sequence number) is generated for the patient. The unique encoded identifiers may be based on the enrolled patient number, but other keys may be used alternatively or in combination.
29. Advantageously, the bar code/QR Code/specific sequence number is sent to a manufacturing entity.
30. The manufacturing entity produces the physical object that will hold the patient's bar code/specific sequence number.

### FIG. 2—Technical Contribution of the Invention

v. The generation of a unique code for the patient and the printing of the documents with the said code improve the reliability of record keeping so that a clinical trial is not jeopardized due to missing documentation such as the patient Informed Consent Form.
vi. The anonymization of patient data allows the clinical trial to be conducted without the risk of contravening existing patient Privacy Regulations.

### FIG. 3—Follow-Up

After patient was enrolled, the Invention facilitates the follow-up during life span of the study.
41. The (authorized) Study personnel uses a PC based application to receive information about the study from the Sponsor's systems (CTMS—Clinical Trials Management System). This can include the number of patients screened at site, patients enrolled, protocol deviations, patients' visits, safety reports, reminders etc . . . (For instance a list of medications which should not be administered during the Clinical Trial or changes in the Protocols of the Study).
42. The Document Database is updated. It also contains information about enrolled patients and the schedule of activities for the Studies.
43. Prior to a medical visit, Patient receives instructions (via Email/SMS) related to the next consultation (Follow-up scheduler).
44. During the consultation, the Investigator uses his smartphone (or another computer device) to launch the application.
45. By scanning the patient's QR/bar code or entering the Enrolled Patient Id, the Investigator receives important information about what must be done during the visit.
46. Investigator can retrieve any related document from the Document

Database Server that may be helpful during the examination.
47. The Investigator can use the application to retrieve the print out of the required documents on a predefined networked printer.
48. The Investigator can also use the application to determine whether the treatment he wants to administer is compatible with the molecule that is being tested as part of the clinical trial.
49. After the visit, the (authorized) Study personnel can update the Document database with information related to the previous visit.

### FIG. 3—Technical Contribution of the Invention

vii. Improves compliance with the study procedures by sending reminders to the relevant stake holders in advance of a consultation. For example, a reminder is sent to a patient to bring a medical file with him prior to the medical consultation.
viii. The primary care physician can validate that the proposed treatment remains compatible with the requirements of the Clinical Trial, thus limiting the risk of excluding a patient due to administration of a conflicting treatment.
ix. Data anonymization is performed and respected during all the process. The unique encoded identifiers allows both data anonymization and an easy management of documents/steps during the clinical trial.

### FIG. 4 Illustrates Early Reporting of a Serious Adverse Event

The invention proposes a mechanism to avoid administering an incompatible treatment for a patient participating in a clinical trial. It also proposes a method to notify the Investigator and the sponsor of a potential Serious Adverse Event.)
61. In the event of an emergency or an accident, a patient may need medical attention which is unrelated to the Clinical Trial.
62. Any (or optionally, only authorized) Emergency Medical Technician (hereafter “EMT”) or physician treating the patient can scan the coded identifier (barcode, QR code, etc . . . ) with their own smartphone, or may enter the patient specific sequence number on a web site or interface. He also indicates a phone number where he can be joined during the next few minutes (in general, his own phone number). The coded identifier will be made available to the patient as a personal wearable effect such as a bracelet or pendant. In the event that the patient is incapacitated or is unconscious, the attending physician can refer to the bracelet or pendant in order to identify the patient as a participant in a Clinical Trial.
63. As soon as the EMT or physician scans the information from the patient, an event will be triggered by the system notifying the Investigator and to the Sponsor via an SMS/Email about the occurrence of the medical event. The fact that the patient was hospitalized is considered to be a Serious Adverse Event.
64. A second SMS/Email is sent to the investigative site, requesting that the investigator or a designated physician get in contact with the physician treating the patient for an accident\incident.
65. This event is recorded in the system activity logs for future reference (the message contains the date, time and the patient's reference\enrolled ID)
66. The system transmits Clinical Trial related messages that can assist the physician to make a determination for the appropriate treatment. Such information can include drug incompatibilities related to the clinical trial and\or emergency procedures for the patient receiving treatment.
67. The investigator can advise the physician with respect to the care of the patient, and ensures that the physician is aware of the medication which the patient is permitted to use while he is participating in a clinical trial.
68. Advantageously, after exchange of information, the (authorized) study personnel can update the Document database with information related to this event.
69. The system preferably sends recurrent notifications to remind the investigator that he must report the incident within a determined deadline, such as 24 hours. This will allow him to comply with his reporting obligations.
70. In this case, the investigator must acknowledge that he has read the notification messages that were received by him.
71. The investigator uses the information related to this event to file a report within the 24 hours timeframe.

### FIG. 4—Technical Contribution of the Invention

ix. When a non-participating EMT/physician initiates a scan of the patient's bar/QR code, a recurring reminder is sent to the relevant stake holders shortly after it is established that a Serious Adverse Event has occurred. This mechanism helps to ensure that the appropriate action is taken within the 24 hr reporting period so as to avoid jeopardizing the entire clinical trial.
x. In the circumstance of a Serious Adverse Event, the attending medical personnel can ascertain that the patient is participating in a clinical trial even though the patient may be incapacitated. The ability of the medical personnel to treat the patient in a manner that does not disqualify him is of utmost importance as it improves the chances of maintaining the number of required study participants.
   Of course, it is clear that the system according to the invention does not give a treatment method in response to a Serious Adverse Event. It only indicates incompatible treatments with the clinical trial. The medical personnel remain free to treat the patient by their own free will.

1. A computer system for patient detection, registration, follow-up and management of related documents during at least one clinical trial, the system comprising:
At least one server linked to a communication network, said server comprising at least one clinical trials database comprising at least eligibility criteria for the or each clinical trial;
An interactive interface adapted:
to display questions relating to eligibility criteria,
to allow entering answers to said questions;
to communicate, through a communication network, with said server and said clinical trials database,
to display an eligibility information,
the server being programmed:
to compare the answers to the eligibility criteria,
to generate said eligibility information as a result of the comparison,
to communicate said eligibility information to the interactive interface,
to generate a unique encoded identifier for each eligible patient participating in a clinical trial
to generate documents comprising said unique encoded identifier and data related to the clinical trial;
A database comprising eligible patient data related to patients who accept to participate in a clinical trial, the data comprising:
personal contact information
numerical copies of documents signed by the patient
A database comprising responsible staff data, the data comprising staff members contact information.

2. A computer system according to claim 1, further comprising a capture device adapted to capture numerical images of documents signed by a patient agreeing to participate in a clinical trial and to send the numerical images to the server through the communication network.

3. A computer system according to claim 1, further comprising a printer linked to the server through the communication network, the printer being able to print documents comprising a unique encoded identifier generated by the server and data related to the clinical trial.

4. A computer system according to claim 1, wherein the database comprising eligible patient data further comprises a schedule of programmed medical visits in relation with the clinical trial, the computer system further comprising a reminder message sender device programmed to send reminder message to each elected patient.

5. A computer system according to claim 4, wherein the server is also programmed:
to receive the unique encoded identifier together with a phone number
to generate a serious adverse event information in response to the reception of the unique code identifier scan and the phone number
to send said serious adverse event information to the responsible staff via the communication network
to transmit Clinical Trial related information to the phone number.

6. A computer system according to claim 5, wherein the server is also programmed to send a message comprising the received phone number to the responsible staff to call this phone number.

7. A process for patient detection, registration follow-up and management of related documents during at least one clinical trial, the process comprising the following steps of:
(a) providing a computer system according to claim 1
(b) answering questions relating to eligibility criteria displayed on an interactive interface;
c) comparing the answers to the eligibility criteria,
d) generating eligibility information as a result of the comparison,
e) communicating said eligibility information to the interactive interface of the provided system,
f) generating a unique encoded identifier for each eligible patient participating in a clinical trial
g) generating documents comprising said unique encoded identifier and data related to the clinical trial.

8. A process according to claim 7 further comprising a step h) of manufacturing an object wearable by a patient and comprising on a visible surface a unique encoded identifier corresponding to said patient.

9. A process according to claim 8, to notify a serious adverse event concerning a given patient, further comprising the steps of:
i) by a person different from the responsible staff, sending to the server via the communication network the unique encoded identifier located on the object worn by the given patient and a phone number where the person may be contacted
j) generating a serious adverse event information in response to the reception of the unique code identifier scan and the phone number
k) sending said serious adverse event information to the responsible staff via the communication network
l) transmitting Clinical Trial related information that can warn the person having sent her phone number in order to avoid treatment and/or drugs incompatible with the clinical trial.

10. A process according to claim 9, further comprising the step m) of sending a message comprising the phone number of the person to the responsible staff to get in contact with the person and help her.

11. A process according to claim 9, further comprising the step n) of sending reminder to the responsible staff to report the incident within a determined deadline.
